(19) United States
(12) Patent Application Publication
(10) Pub. No.: US 2006/0102807 A1
(43) Pub. Date: May 18, 2006

(54) Cable bracket for a bicycle

(76) Inventors: Meng-Hung Chen, Tantzu Hsiang (TW); Jin-Long Lee, Houli Hsiang (TW)

Correspondence Address: RABIN & Berdo, PC, 1101 14TH STREET, NW, SUITE 500, WASHINGTON, DC, 20005, US

(21) Appl. No.: 11/156,449

(22) Filed: Jun. 21, 2005

(30) Foreign Application Priority Data
Nov. 12, 2004 (TW) 093134695

(51) Int. Cl. F16L 3/08

(52) U.S. Cl. 248/65

(57) ABSTRACT

A cable bracket for a bicycle has a frame and a resilient fastener. The frame is preferably Y-shaped and has a body with a looped end and two branched ends. The looped end has a cable recess for holding at least one cable. Each branched end has a hook for receiving the resilient fastener. When the two branched ends embrace a tube of the bicycle at a proper position, the resilient fastener has two ends secured on the hooks to make the frame attach on the tube firmly. Thereby, the cable bracket is detachably mounted on the tube. Moreover, the looped end only keeps the cable within the cable recess and does not constrict the cable so that the cable is kept in its original form without deformation or disturbance in operation.

### BACKGROUND OF THE INVENTION

1. Field of the Invention

The present invention relates to a cable bracket for a bicycle, and more particularly a cable bracket that can be detached conveniently.

2. Description of Related Art

To avoid brake cables or gear cables on a bicycle swinging when the bicycle is being ridden, bicycle manufacturers usually tie the cables onto the frame of the bicycle. With reference to FIG. 6, a conventional device for tying cables on the bicycle is a strip (50) such as cable pull-tie. The strip (50) has an elongated body with a toothed inner face and two ends. One end of the strip (50) has a latch head (52) and the other end of the strip is a tapered tongue (51). When the strip (50) is used to tie a cable (40) to on a fork (A) of the bicycle, the elongated body surrounds the cable (40) and the fork (A) together. Then, the tongue (51) penetrates through the latch head (52) and is pulled out to fasten the cable (40) on the fork (A), wherein the latch head (52) bites the toothed inner face for securing the cable (40).

Although the strip (50) efficiently and conveniently ties the cable (40) on the head tube (A), some drawbacks occur:

1. The fitting of the strip (50) is irreversible, therefore, the strip (50) must be broken and can not be reused when the cable (40) needs to be removed.

2. The strip (50) directly fastens the cable (40) on the fork (A) so that the cable (40) is compressed between the strip (50) and the fork (A). Therefore, a movable wire (not shown), such as a metal wire connecting the brake (not shown) and the brake lever (not shown), inside the cable (40) is also constricted and so movement of the inner cable is restricted when a rider pulls the brake lever. Thus, braking efficiency of the bicycle is reduced and this may lead to injury or death, especially for very young or old riders that may not have sufficient strength to overcome the resistance.

3. The strip (50) has a simple structure but does not have a good appearance to correspond to the esthetics of modern bicycles. Moreover, the cable (40) constrained by the strip (50) is curved and twisted so the cable (40) is not neat in appearance.

To overcome the shortcomings, the present invention provides a cable bracket for a bicycle to mitigate and obviate the aforementioned problems.

### SUMMARY OF THE INVENTION

The main objective of the invention is to provide a cable bracket that can be conveniently detached and does not influence operation of a corresponding cable.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of the cable bracket for a bicycle in accordance with the present invention;

FIG. 2 is a cross-sectional view of the cable bracket combined with a tube of the bicycle;

FIG. 3 is an operational side view of two cable brackets mounted on the fork of the bicycle to hold a cable in position by a resilient fastener;

FIG. 4 is a top view of another embodiment of the cable bracket in accordance with the present invention;

FIG. 5 is a cross-sectional view of the cable bracket in accordance with FIG. 4, wherein the cable bracket is combined with the head tube; and

FIG. 6 is an operational side view of two conventional strips mounted on the head tube.

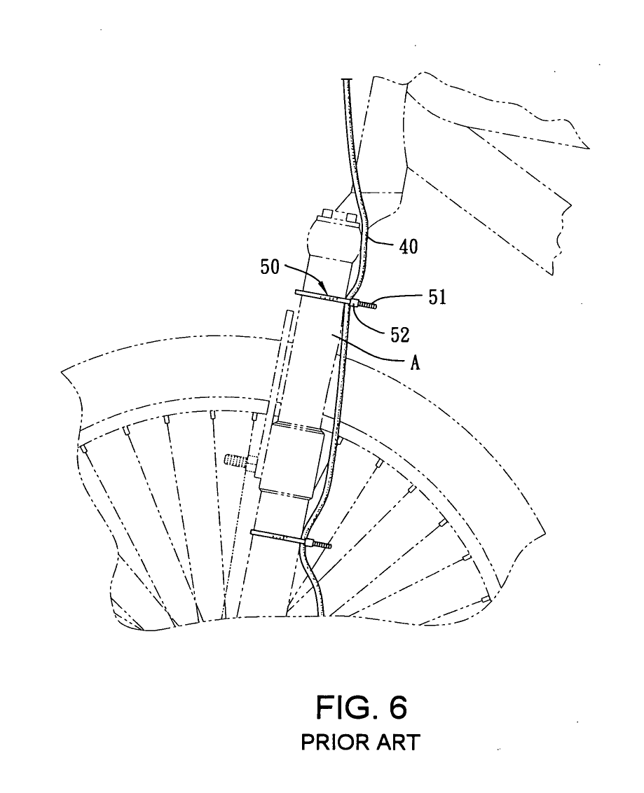

### DETAILED DESCRIPTION OF PREFERRED EMBODIMENT

A cable bracket for a bicycle in accordance with the present invention comprises a frame and an optional resilient fastener. The frame is preferably Y-shaped and has a looped end and two branched ends. The looped end has a cable recess for holding at least one cable. Each branched end has a hook for retaining the resilient fastener. When the two branched ends embrace a tube of the bicycle at a proper position, the resilient fastener has two ends secured on the hook to make the frame attach on the tube firmly. Thereby, the cable bracket is detachably mounted on the tube. Moreover, the looped end only keeps the cable within the cable recess and does not constrict the cable so that the cable is kept in its original straight form without deformation and disturbance in operation.

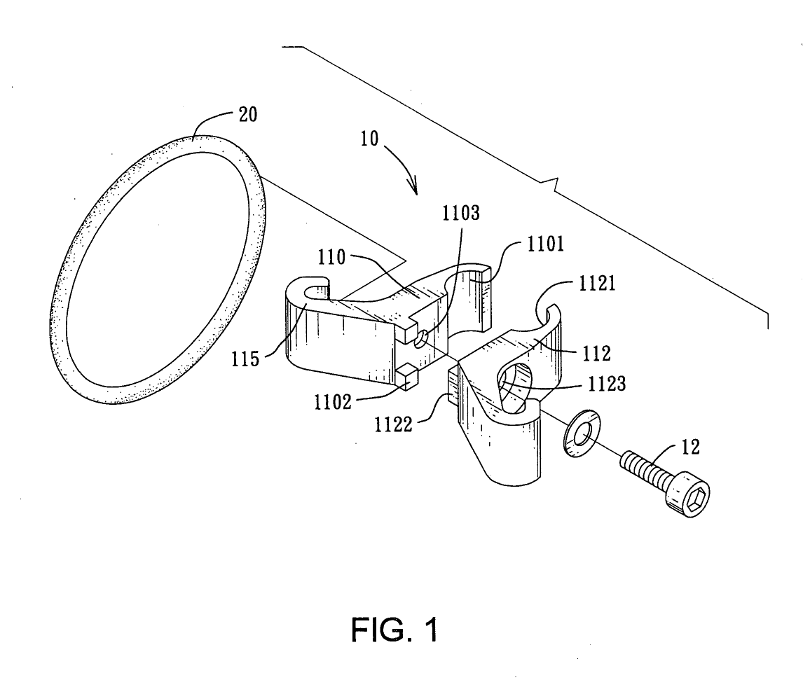

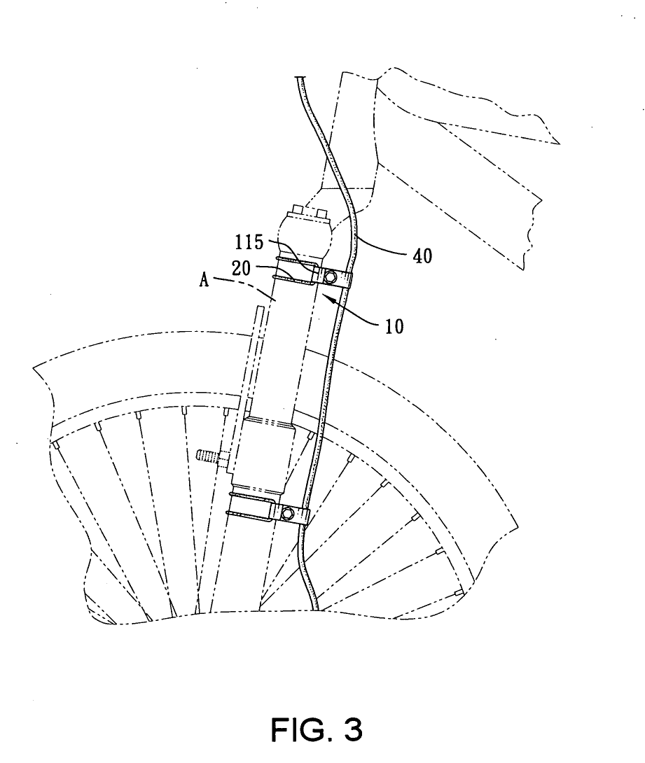

With reference to FIGS. 1, 2 and 3, a preferred embodiment of the cable bracket for a bicycle comprises a body (10) and a resilient fastener (20).

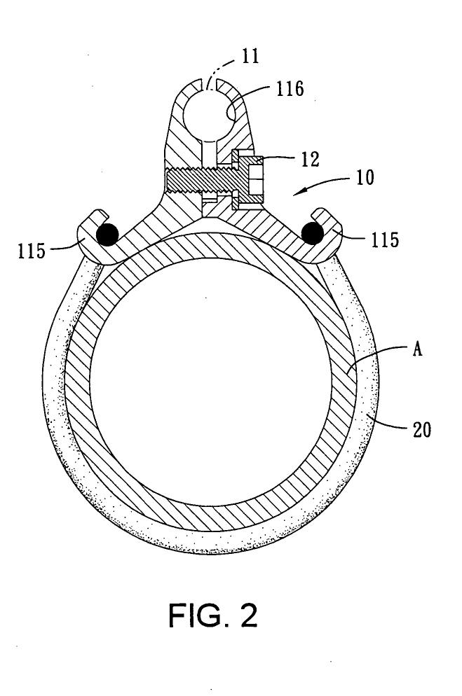

The body (10) is Y-shaped and composed of two half bodies (110, 112) and has a securing device (12) combining the two half bodies (110, 112) together. Each half body (110, 112) is L-shaped and symmetrical to the other one. Each half body (110, 112) has an abutting end (not numbered) with an inner face, an extending end (not numbered) with a hook (115) and a middle section with either a threaded hole (1103) or a plain hole (1123) between the abutting end and the extending end. The abutting end on one half body (110, 112) further has a groove (1101, 1121) defined in the inner face to correspond to the other on the other half body (110, 112). When the abutting end on one half body (110, 112) attaches to the corresponding abutting end on the other half body (110, 1112), the grooves (1101, 1121) match with each other to perform a cable recess (116, in FIG. 2) to achieve a looped end. Meanwhile, the holes (1103, 1123) align with each other to allow the securing device, i.e. a screw (12) to enter the holes (1103, 1123) to combine the two half bodies (110, 112) together. Wherein, the extending ends on the two half bodies (110, 112) perform two branched ends with a space adapted to abut the tube (A) between the two branched ends.

Moreover, each half body (110, 112) further has at lest one positioning block (1102, 1122) formed on the inner face at the middle section to engage with a corresponding positioning block (1102, 1122) on the other half body (110, 112) to avoid the two half bodies (110, 112) rotating relative to each other. ?? Additionally, as shown in FIG. 2, a slit (11) with a width narrower than a diameter of the cable is defined at a joint between the abutting ends of the two half bodies (110, 112) to allow the cable to be squeezed through the slit (11) into the cable recess (116). The cable (40) cannot escape the cable recess (116) due to the restriction provided by the slit (11).

With particular reference to FIG. 2, the resilient fastener (20) is preferably a rubber band or another resilient loop to detachably engage with two hooks (115) on the extending ends of the two half bodies (110, 112). When the resilient fastener (20) combines with the body (10), the bracket can be detachably and conveniently mounted on a tube (A) of the bicycle. Although the bracket of the present invention is shown to be attached to a fork of the bicycle, it is to be appreciated that it is practical to attach it to any part of the bicycle frame and any device that has tubes to which cables must be attached.

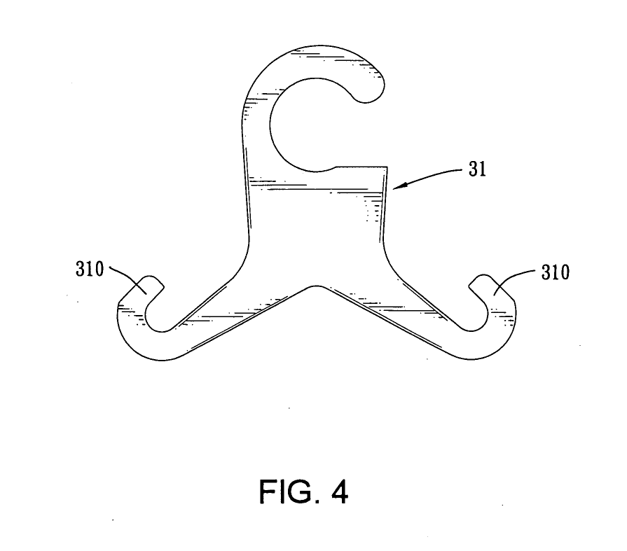

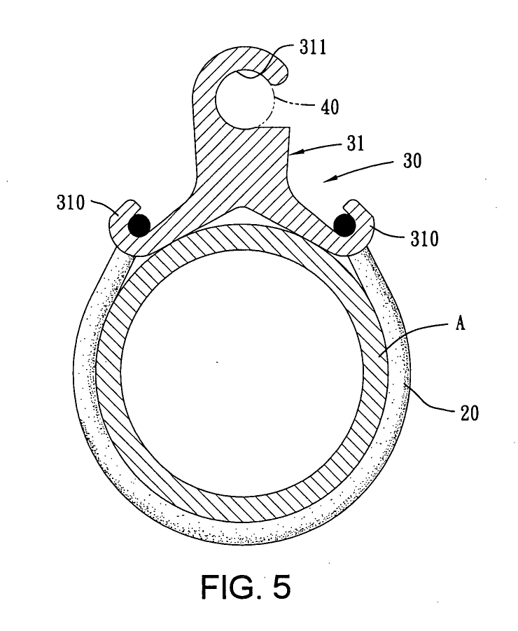

With reference to FIGS. 4 and 5, another preferred embodiment of the body (30) is shown, wherein the body (30) is one-piece element with a looped end (31) and two branched ends. The looped end (31) of the body (30) has a C-clasp (311) to movably and correspondingly hold the cable (40) and each branched end has a hook (310) formed at a distal end. In this embodiment, the body (30) can be directly attached to the tube (A) with combination as shown in the foregoing embodiment. The operational method to engage with the resilient fastener (20) is the same as the foregoing description, therefore, redundant illustration is obviated here.

The cable bracket for a bicycle has the following advantages:

1. The cable bracket can be detachably mounted on the tube (A) in cooperation with the resilient fastener to change its position.

2. The cable bracket slidably holds the cable (40) to keep appearance of the bicycle neat. Moreover, the cable bracket does not compress or deform the cable (40), therefore, the cable (40) such as a brake cable or a gear cable can move freely to keep operational efficiency good.

Therefore, the cable bracket for a bicycle is practical and useful. Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A cable bracket for a bicycle comprising:
a body being Y-shaped and having a looped end formed on one end of the body, and having a cable recess; and
two branched ends formed on the body and opposite to the looped end, wherein two hooks are respectively formed on the two branched ends; and
a fastener (20) detachably connected between the two branched ends at the hooks.

2. The cable bracket as claimed in claim 1, wherein the frame (30) is formed as a single piece and having a C-clasp formed on the looped end to define the cable recess (311).

3. The cable bracket as claimed in claim 1, wherein the frame is composed of two half bodies (1101, 1112) in L-shaped form and a securing device (12) combining the two half bodies (110, 112) together;
each of the two half bodies having:
an abutting end with an inner face and a groove (1101, 1121) defined in the inner face, wherein the groove (1101, 1121) on one half body (110, 112) matches with a corresponding groove (1101, 1121) on the other half body (110, 112) to perform the cable recess;
an extending end connected to the abutting end and having the one of the hooks to perform the branched end when the two half bodies (110, 112) are combined; and
a middle section formed between the abutting end and the extending end and having a hole (1103, 1123) to engage with the securing device (12), wherein the hole (1103, 1123) on one half body (110, 112) matches with a corresponding hole (1103, 1123) on the other half body (110, 112).

4. The cable bracket as claimed in claim 3, wherein each of the two half bodies (110, 112) further has at least one positioning block (1102, 1122) formed on the inner face at the middle section to engage with a corresponding positioning block (1102, 1122) on the other half body (110, 112).

5. The cable bracket as claimed in claim 3, wherein the securing device is a screw.

6. The cable bracket as claimed in claim 4, wherein the securing device is a screw.

7. The cable bracket as claimed in claim 1, wherein the fastener is a resilient loop.

8. A body of a cable bracket for a bicycle, wherein
the body is Y-shaped and has:
a looped end formed on one end of the body and having a cable recess;
two branched ends formed on the body and opposite to the looped end, each of the branched ends having a hook.

9. The body as claimed in claim 8, wherein the frame (30) is formed as a single piece and having a C-clasp formed on the looped end to define the cable recess (311).

10. The cable bracket as claimed in claim 8, wherein the frame is composed of two half bodies (110, 112) in L-shaped form and a securing device (12) combining the two half bodies (110, 112) together;
each of the two half bodies having:
an abutting end with an inner face and a groove (1101, 1121) defined in the inner face, wherein the groove (1101, 1121) on one half body (110, 112) matches with a corresponding groove (1101, 1121) on the other half body (110, 112) to perform the cable recess (116);
an extending end connected to the abutting end and having one of the hooks to perform the branched end when the two half bodies (110, 112) are combined; and
a middle section formed between the abutting end and the extending end and having a hole (1103, 1123) to engage with the securing device (12), wherein the hole (1103, 1123) on one half body (110, 112) matches with a corresponding hole (1103, 1123) on the other half body (110, 112) wherein the securing device (12) is received securely in the holes (1103, 1123) when two half bodies (110, 112) combine together.

11. The cable bracket as claimed in claim 10, wherein each of the two half bodies (110, 112) further has at lest one positioning block (1102, 1122) formed on the inner face at the middle section to engage with a corresponding positioning block (1102, 1122) on the other half body (110, 112).

12. The cable bracket as claimed in claim 10, wherein the securing device is a screw.

13. The cable bracket as claimed in claim 11, wherein the securing device is a screw.
